(19) United States
(12) Patent Application Publication
(10) Pub. No.: US 2011/0063274 A1
(43) Pub. Date: Mar. 17, 2011

(54) BACKLIGHT ASSEMBLY AND DISPLAY APPARATUS HAVING THE SAME

(76) Inventors: Seung-Wan KIM, Asan-si (KR); Won-Hyoung Kang, Anyang-si (KR); Moonshik Kang, Yongin-si (KR); Min-Gyu Kim, Cheonan-si (KR)

(21) Appl. No.: 12/829,073

(22) Filed: Jul. 1, 2010

(30) Foreign Application Priority Data
Sep. 14, 2009 (KR) 10-2009-0086619

(51) Int. Cl. G06F 3/038; H05B 37/02; G09G 3/20

(52) U.S. Cl. 345/211; 315/185 R; 345/55

(57) ABSTRACT

In a backlight assembly and a display apparatus having the backlight assembly, a plurality of lamps are housed in a housing having grounded sidewalls, where each of the lamps has at least one bend and series circuits are formed by respective sets of two or more of the bent lamps; where each series connected set of lamps is driven by an AC driving voltage of sufficient magnitude to light the series connected set of lamps, the AC driving voltage being produced by an AC step-up transformer circuit and where each series connected set has its series circuit formed by a lamp-to-lamp connection made through a grounded sidewall of the container. High and low voltage portions of each series connected set of lamps are positioned to reduce electrostatic discharge as between high voltage portions of the series and a nearby grounded sidewall of the container.

### CROSS-REFERENCE TO RELATED APPLICATION

This application relies for priority upon Korean Patent Application No. 2009-86619 filed on Sep. 14, 2009, the contents of which are herein incorporated by reference in its entirety.

### BACKGROUND

1. Field of Disclosure

The present disclosure of invention relates to a backlight assembly and an image display apparatus having the same. More particularly, the present disclosure relates to a backlight assembly capable of reducing the number of parts therein and improving brightness uniformity thereof and a display apparatus having the backlight assembly.

2. Description of Related Technology

A liquid crystal display (LCD) includes a liquid crystal display panel structured for displaying a signal-defined image and a backlight assembly providing a light to the liquid crystal display panel.

As a light source for the backlight assembly, cold cathode fluorescent lamps have been widely used. According to the employed arrangement of its light sources, the backlight assembly may be classified as an edge-illumination type backlight assembly in which a lamp is positioned adjacent to an edge of the liquid crystal display panel or as a direct-illumination type backlight assembly in which a plurality of lamps is positioned underneath the liquid crystal display panel.

Recently, as sizes of liquid crystal display panels have become larger, the direct-illumination type backlight assembly has been widely used for a display apparatus which requires high brightness.

The conventional direct-illumination type backlight assembly employs straight-line-shaped lamps in order to obtain the desired high brightness and brightness uniformity as well as compact packing of lamps, one adjacent to the next.

### SUMMARY

In accordance with the present disclosure, a backlight assembly is provided that has a reduced number of parts therein (as compared to backlight assembly employing straight-line-shaped lamps) and which provides improved brightness uniformity to the overlying LCD panel.

According to exemplary embodiment, a backlight assembly includes a container having grounded electrically conductive parts; a plurality of lamps each having one or more bends and linear lamp segments extending from the one or more bends to thus define a corresponding lightable length of the lamp, the lamps being contained and positioned in the container such that their respective linear lamp segments all extend substantially in a first direction (D1) so as to be substantially parallel to one another, each of the lamps having a first electrical terminal (H) for receiving a voltage of relatively high absolute magnitude and a second electrical terminal (G) for receiving a voltage of relatively low absolute magnitude where the different between the received high and low voltage magnitudes is sufficient to keep that lamp lit; and a voltage step-up transformer circuit having one or more output windings, each output winding having at least two output terminals (O1, O2) where between there can develop as a result of a predetermined input AC voltage being applied to the step-up transformer circuit, an AC output voltage (Vₒᵤₜ₁₂) of sufficient magnitude to light a connected series of at least two of the lamps, wherein for a given winding, said connected series of at least two lamps is formed by a corresponding two or more of the bent lamps each having the second electrical terminal thereof (the G terminal thereof) connected to an adjacent and grounded electrically conductive part of the container and having the first electrical terminal thereof (the H terminal thereof) connected to a corresponding one of the at least two output terminals of the given winding. In one embodiment, the second terminal (the G terminal) of an outermost first lamp among the contained lamps is positioned close to a corresponding first grounded sidewall of the container and the second terminal (the G terminal) of an outermost second lamp among the contained lamps is positioned close to a corresponding second grounded sidewall of the container while the respective first electrical terminals (the H terminals) of the first and second outermost lamps are positioned substantially far away from the first and second grounded sidewalls of the container so that electrostatic leakage current is not easily discharged from the high-voltage receiving first electrical terminals (the H terminals) of the first and second outermost lamps to the grounded first and second sidewalls of the container.

Other aspects of the present teachings will be more readily appreciated from the following detailed description. It will be seen that lamp segment brightness near the grounded sidewalls of the container may be prevented from being deteriorated by electrostatic discharge by virtue of this arrangement, thereby improving brightness uniformity of the backlight assembly.

### BRIEF DESCRIPTION OF THE DRAWINGS

The above and other advantages of the present teachings will become readily apparent by reference to the following detailed description when considered in conjunction with the accompanying drawings wherein:

FIG. 1 is a plan view showing a backlight assembly according to a first exemplary embodiment;

FIG. 2 is a circuit diagram showing a connection relation between a transformer circuit and a plurality of lamps of FIG. 1;

FIG. 3 is a plan view showing a backlight assembly according to another exemplary embodiment;

FIG. 4 is a circuit diagram showing a connection relation between a transformer circuit and a plurality of lamps of FIG. 3.

FIG. 5 is a plan view showing a display apparatus employing a backlight assembly of FIG. 1;

FIG. 6 is a diagram showing brightness measurement points for brightness values of a display panel of FIG. 5;

FIGS. 7A and 7B are tables showing brightness values measured at brightness measurement points of FIG. 6;

FIG. 8 is a plan view showing a backlight assembly according to another exemplary embodiment; and

FIG. 9 is a circuit diagram showing a connection relation between a transformer circuit and a plurality of lamps of FIG. 8.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the present teachings.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure is provided in greater detail with reference to the accompanying drawings.

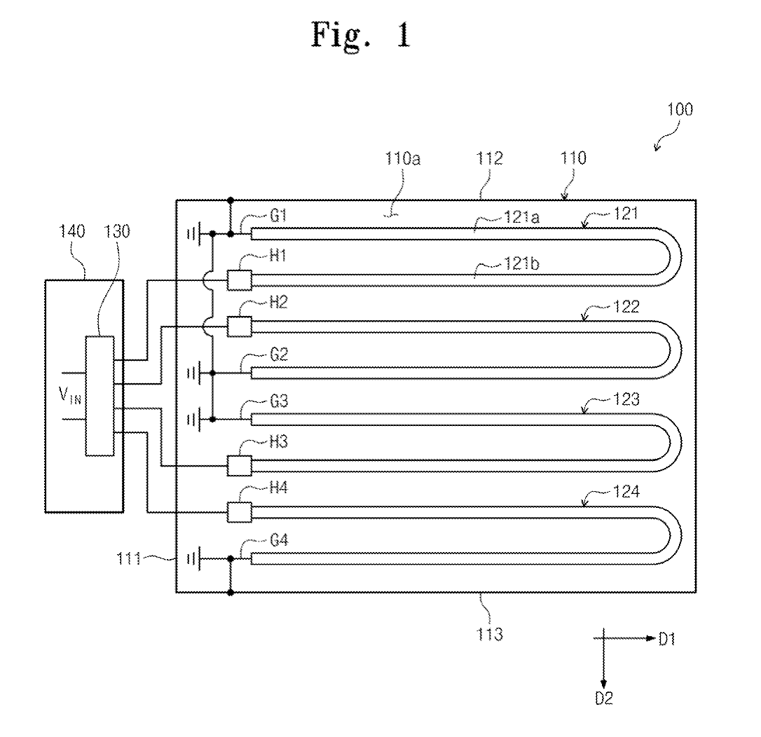

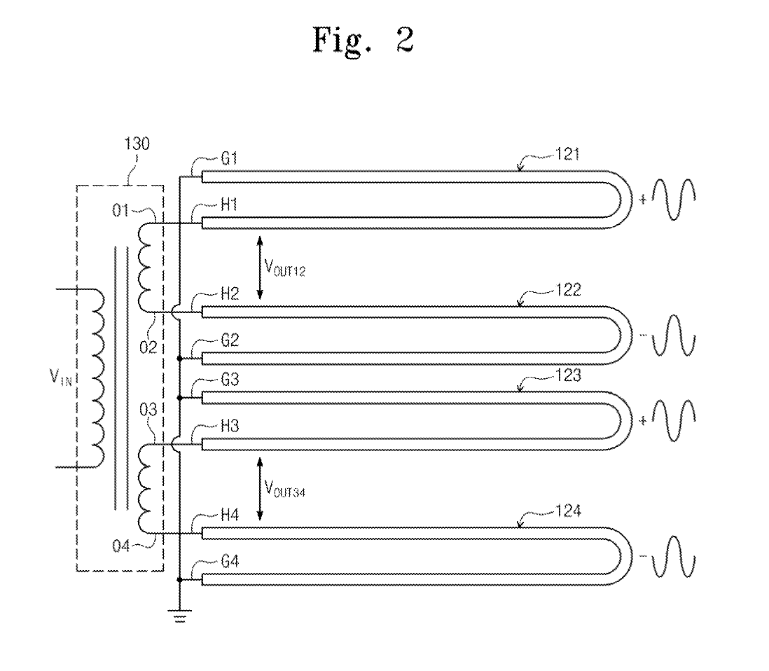

FIG. 1 is a plan view showing a backlight assembly according to a first exemplary embodiment 100. FIG. 2 is a circuit diagram showing a possible connection relation between a transformer circuit and a plurality of lamps in one embodiment, according to FIG. 1.

Referring to FIGS. 1 and 2, the schematically illustrated backlight assembly 100 includes an electrically conductive container 110, a plurality of lamps each having at least one U-type bend, 121, 122, 123, and 124, a transformer circuit 130, and an inverter printed circuit board (PCB) 140.

In one embodiment, the container 110 has a rectangular box shape and the lamps 121˜124 are contained in a containing space 110a of the container 110. The illustrated exemplary embodiment 100 has four lamps, for example, a first lamp 121, a second lamp 122, a third lamp 123, and a fourth lamp 124, each having a single U-bend at a right side thereof as shown in FIG. 1. However, the number of the lamps in other embodiments need not be limited to four and the number of U-type bends need not be limited to one. That is, in case that a size of the backlight assembly 100 becomes larger or a required brightness increases, the number of the lamps may increase to more than four. Also, since the first to fourth lamps 121˜124 have the same structure and function in the present exemplary embodiment, for the convenience of explanation, only the first lamp 121 will be described in greater detail as a representative example.

The first lamp 121 includes a high-voltage receiving, first terminal H1 and a grounded second terminal G1, where the H1 and G1 terminals are respectively disposed at opposed ends of the longitudinal length of the first lamp 121 and where the H1 and G1 terminals are structured to receive a driving high-voltage signal that can cause the lamp 121 to light up. As an example, the illustrated first lamp 121 is bent once, so the first lamp 121 has a U-shape and includes two straight-line-shaped lamp segments 121a and 121b as well as an interposed bent segment that joins linear lamp segments 121a and 121b. Thus, the first terminal H1 and the second terminal G1 of the first lamp 121 may be arranged at respective terminal ends of the linear lamp segments 121a and 121b so as to face a first adjacent sidewall 111 of the container 110.

In other embodiments, the number of the straight-line-shaped lamp segments per lamp need not be limited to just two and may increase according to the size of the backlight assembly 100 and the required brightness. The lamp tubes proper may be in a first plane (parallel to the D1˜D2 plane) while their respective H and G terminals may bend down for connection in a second plane (PCB plane) disposed below the first plane.

Referring to FIG. 2, here the lamps are illustrated to be spaced unevenly due to other aspects of the schematic although it is to be understood that generally they will have their linear segments spaced according to a regular pitch interval for thereby providing a relatively uniform distribution of light intensity. The illustrated high-voltage transformer circuit 130 receives a relatively low voltage AC signal at its input side (left side) and it boosts the input AC voltage signal (Vᵢₙ) to generate one or more high-voltage AC driving signals (Vₒᵤₜ₁₂ and Vₒᵤₜ₃₄) for application to corresponding high-voltage terminals H1 and H2 (shown receiving the Vₒᵤₜ₁₂ signal) and to corresponding high-voltage terminals H3 and H4 (shown receiving the Vₒᵤₜ₃₄ signal) of the respective first to fourth lamps 121˜124. Of importance, the generated high-voltage AC driving signals (e.g., Vₒᵤₜ₁₂) are each of sufficient voltage to ignite and/or keep lit a series connected circuit having two or more of the lamps connected series wise in that series connected circuit. In the present exemplary embodiment, the transformer circuit 130 may be a 4-out/2-in transformer having four output terminals and two input terminals, including for example, a first output terminal O1, a second output terminal O2, a third output terminal O3, and a fourth output terminal O4. (The high-voltage AC signals, Vₒᵤₜ₁₂ and Vₒᵤₜ₃₄, developed at respective transformer output terminal pairs O1/O2 and O3/O4 are also referred to herein as high-voltage AC signals, V_{O12} and V_{O34} respectively.)

More specifically, and as shown, the first output terminal O1 of transformer circuit 130 is connected to the first terminal H1 of first lamp 121, the second output terminal O2 is connected to first terminal H2 of second lamp 122, the third output terminal O3 is connected to first terminal H3 of third lamp 123, and the fourth output terminal O4 is connected to first terminal H4 of fourth lamp 124. Thus, the one transformer circuit 130 may provide the driving power to the first to fourth lamps 121˜124. Second terminals G1˜G4 of the first to fourth lamps 121˜124 are grounded. The G1-ground-G2 connection completes the series-connected circuit which has V_{O12} driving AC current through its balanced loads, namely, lamps 121 and 122. The G3-ground-G4 connection completes the series circuit which has V_{O34} driving AC current through its balanced loads, namely, lamps 123 and 124.

As described above, when the one transformer circuit 130 drives the four lamps 121˜124 as shown and described, the number of high-voltage transformer windings needed or lengths of high-voltage wires needed to be arranged across areas in the backlight assembly 100 decreases and the number of parts arranged on the inverter PCB 140 can be reduced, thereby decreasing a size of the inverter PCB 140.

For example, an inverter PCB for a 32-inch display apparatus employing two transformers to drive four U-shaped lamps (one winding for each lamp, with that winding (not shown) having output voltage sufficient to drive no more than one lamp) has a size of about 386 mm by 63 mm or about 330 mm by 63 mm. However, as shown in the present exemplary embodiment, in case that the one transformer is used to drive the four U-shaped lamps (one high-voltage winding for every two, series-connected lamps), the size of the inverter PCB is reduced to have a size of about 243 mm by 63 mm (thus reducing the 386 mm original dimension by about 37%). As a consequence, the size of the inverter PCB may be advantageously decreased by decreasing the number of the transformers and increasing the number of lamps serviced by each high-voltage winding.

Meanwhile, the first to fourth lamps 121˜124 have their respectively linear segments (e.g., 121a, 121b) extending a first direction D1, and the first to fourth lamps 121˜124 are packed one after the next in a second direction D2 that is substantially perpendicular to the first direction D1. That is, the first to fourth lamps 121˜124 are arranged in the second direction D2 in order of the first lamp 121, then the second lamp 122, the third lamp 123, and finally the fourth lamp 124.

The first lamp 121 that is positioned at an outermost position among the four lamps 121˜124 is the one most adjacent to top sidewall 112 of the container 110, which is arranged in parallel to the first direction D1, and the fourth lamp 124 is the one that is positioned most adjacent to bottom sidewall 113 of the container 110, which is opposite to the top sidewall 112. The grounded second terminal G1 of the first lamp 121 is closer to the also grounded top sidewall 112 than is the high-voltage first terminal H1 of the first lamp 121. Similarly, the grounded second terminal G4 of the fourth lamp 124 is closer to the bottom sidewall 113 than is the first terminal H4 of the fourth lamp 124.

In general, the sidewalls of the container 110 are maintained at a ground potential. Thus, if hypothetically speaking, the first terminals H1 and H4 had been arranged more adjacent to the first and second sidewalls 112 and 113 of the container 110, respectively, a larger leakage current (electrostatic breakdown leakage) would be generated as between the container 110 and the first and fourth lamps 121 and 124 positioned at both outermost positions. Such leakage currents can cause deterioration in brightness for the lamps disposed near the grounded first and second sidewalls 112 and 113 of the container 110.

In order to prevent deterioration of the brightness, the first terminal H1 of the first lamp 121 is arranged closer to a center portion of the container 110 than the second terminal G1, and the first terminal H4 of the fourth lamp 124 is arranged closer to the center portion of the container 110 than the second terminal G4. Since the second terminals G1 and G4 receive a voltage that is relatively lower than the voltage applied to the first terminals H1 and H4, the leakage current between the first lamp 121 and the first sidewall 112 and the leakage current between the fourth lamp 124 and the second sidewall 113 may be reduced. Therefore, the deterioration of the brightness of lamps near the first and second sidewalls 112 and 113 may be prevented, thereby improving brightness uniformity of the backlight assembly 100.

In addition, the to be grounded, second terminals G1 and G4 of the first and fourth lamps 121 and 124 may directly make contact with the adjacent sidewall of container 110 to be thereby grounded through the container 110. In addition, second terminals G2 and G3 of the second and third lamps 122 and 123 may be directly or indirectly connected to the second terminals G1 and G4 of the first and fourth lamps 121 and 124. As described above, when the second terminals G1, G2, G3, and G4 of the first to fourth lamps 121˜124 are grounded through the container 110, no additional ground wiring needs to be used to ground the second terminals G1, G2, G3, and G4 and there is no need to have grounding terminals on the inverter PCB 140 for connecting to the grounded second terminals G1, G2, G3, and G4 of the lamps. That is, the ground terminal may be removed from the inverter PCB 140, so that the size and cost of the inverter PCB 140 may be thus reduced. (Plug-in socket sets (not shown) into which the terminals of the U-shaped lamps are removably inserted may have one grounded-to-the-container socket that is also affixed to the bottom of the container and one HV socket that is insulated from the container for each lamp, thus simplifying connection operations during manufacture.)

As shown in FIGS. 1 and 2, the first terminal H1 of the first lamp 121 is adjacent to the first terminal H2 of the second lamp 122, the first terminal H3 of the third lamp 123 is adjacent to the first terminal H4 of the fourth lamp 124, and the second terminal G2 of the second lamp 122 is adjacent to the second terminal G3 of the third lamp 123. Accordingly, the terminals of the first to fourth lamps 121˜124 may be arranged in order of “G1H1H2G2G3H3H4G4”. In other words, grounded terminals are generally grouped together and high-voltage terminals are generally grouped together.

As illustrated in FIG. 2, the voltage phase applied to the first terminal of one (e.g., H1) of two adjacent lamps has a respectively first phase (e.g., plus, +) that is opposite to the voltage phase (e.g., minus, −) applied to the first terminal of remaining one (e.g., H2) of the two adjacent lamps. In other words, the first terminal H1 of the first lamp 121 receives the driving power having a phase opposite to a phase of the driving power applied to the first terminal H2 of the second lamp 122, the first terminal H2 of the second lamp 122 receives the driving power having a phase opposite to a phase of the driving power applied to the first terminal H3 of the third lamp 123, and the first terminal H3 of the third lamp 123 receives the driving power having a phase opposite to a phase of the driving power applied to the first terminal H4 of the fourth lamp 124. Thus, electric field potentials cancel out between the adjacent lamps and a waterfall noise may be prevented from occurring between the two adjacent lamps.

Further, since a high voltage is applied to the first terminals H1, H2, H3, and H4, an area where the first terminals H1, H2, H3, and H4 are adjacent to each other may have a relatively higher brightness than other areas. For example, in case that the terminals of the first to fourth lamps 121˜124 are arranged in the order of “G1H1H2G2G3H3H4G4”, the brightness of upper and lower areas of a display screen of the display apparatus will not be relatively lower than the other areas. Therefore, the backlight assembly 100 having a structure in which the terminals are arranged as the above-mentioned may have an advantage in displaying subtitles in the lower area when used for a television monitor or a screen.

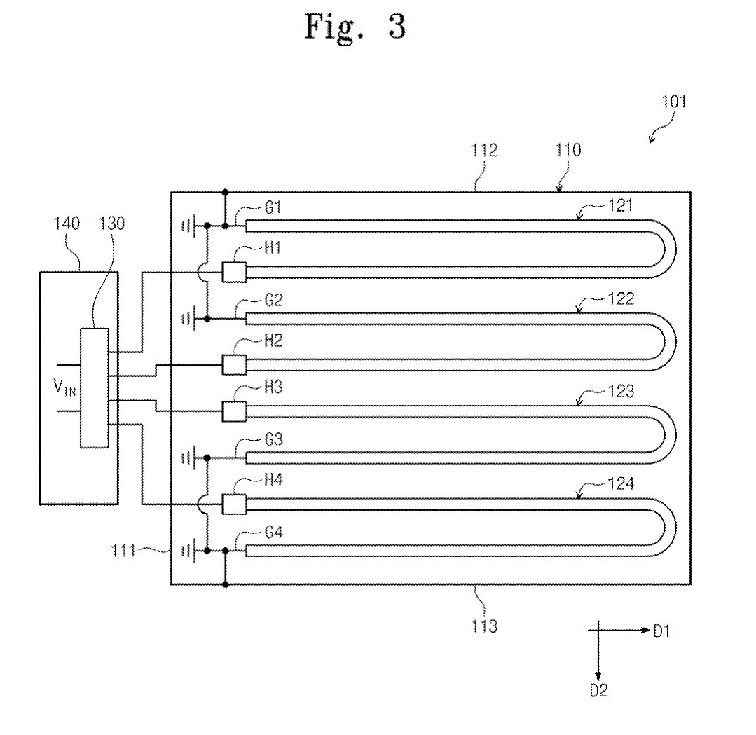

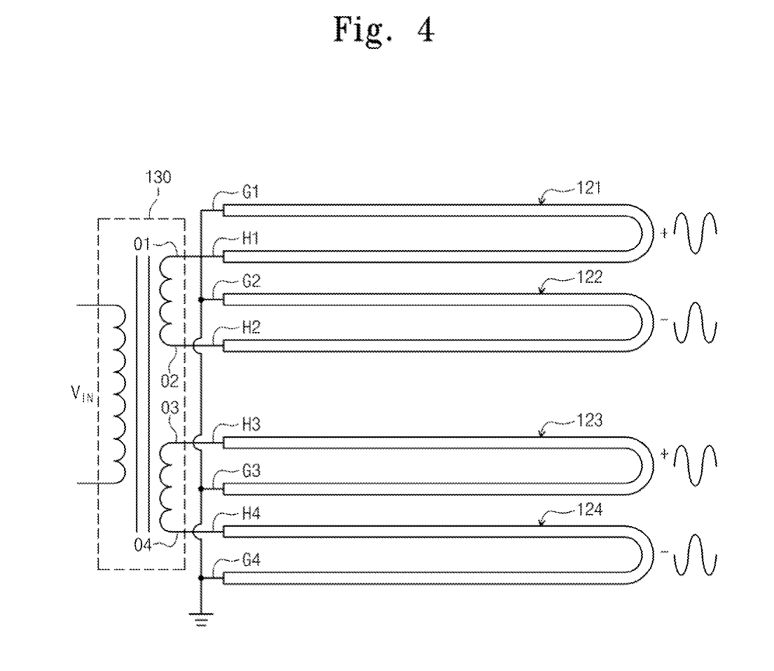

FIG. 3 is a plan view showing a backlight assembly according to another exemplary embodiment 101. FIG. 4 is a circuit diagram showing a connection relation between a transformer and a plurality of lamps of FIG. 3. In FIGS. 3 and 4, the same reference numerals denote the same elements in FIGS. 1 and 2, and thus the detailed descriptions of the same elements will be omitted. Basically, in FIGS. 3-4, H2 and H3 are grouped adjacent to one another in the middle of D2 extent while in FIGS. 1-2, it is G2 and G3 that are grouped adjacent to one another in the middle.

Referring to FIGS. 3 and 4, a backlight assembly 101 according to the present exemplary embodiment has substantially the same structure as the backlight assembly 100 of FIG. 1 except for arrangement order of terminals of the second and third lamps, 122˜123.

Particularly, in the present exemplary embodiment, a first terminal H2 of a second lamp 122 is adjacent to a first terminal H3 of a third lamp 123, a first terminal H1 of a first lamp 121 is adjacent to a second terminal G2 of the second lamp 122, and a first terminal H4 of a fourth lamp 124 is adjacent to a second terminal G3 of the third lamp 123. Thus, the terminals of the first to fourth lamps 121˜124 may be arranged in the order of “G1H1G2H2H3G3H4G4”.

When the terminals are arranged in the order of “G1H1G2H2H3G3H4G4”, the brightness may be presented at relatively high in a center of a display screen of the display apparatus. Thus, the backlight assembly 101 having the structure in which the terminals are arranged as the above-described may have an advantage when employed as a monitor or a display device of a notebook computer.

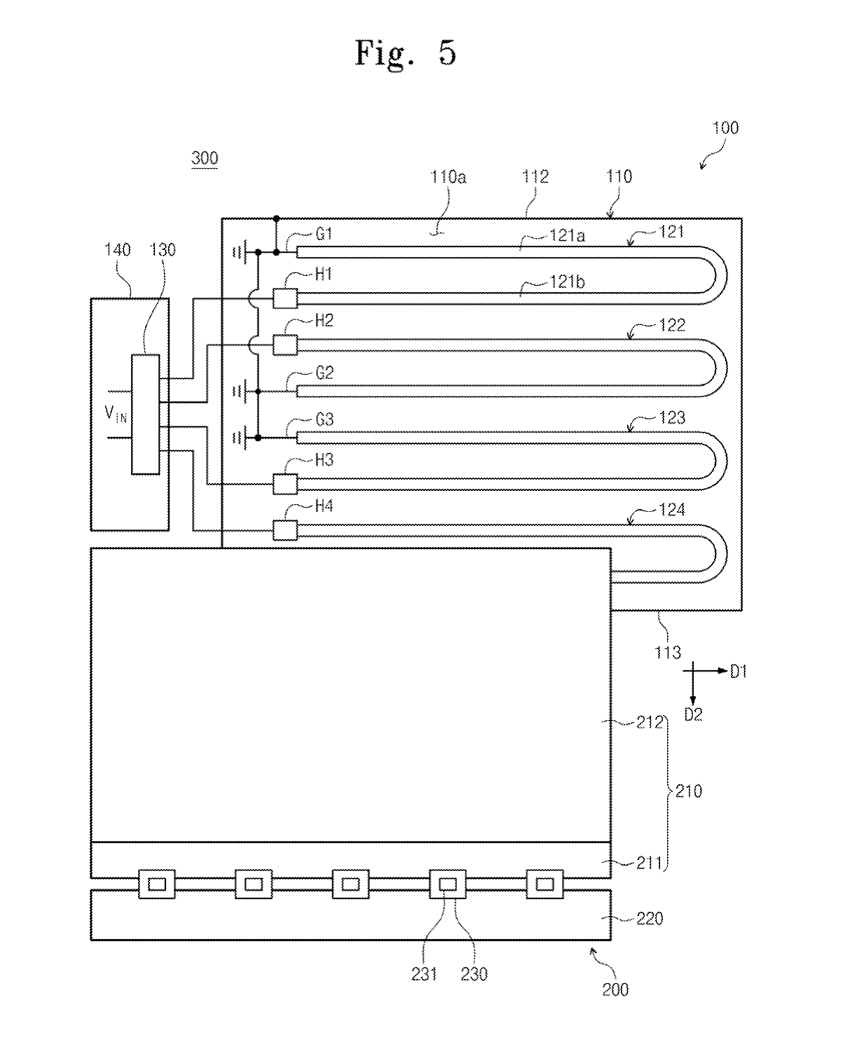

FIG. 5 is a plan view showing a display apparatus employing the backlight assembly of FIG. 1. In FIG. 5, the same reference numerals denote the same elements in FIG. 1, and thus the detailed descriptions of the same elements will be omitted.

Referring to FIG. 5, a display apparatus 300 includes a backlight assembly 100 generating a light and a display unit 200 receiving the light to display an image. The display unit 200 includes a display panel 210 and a printed circuit board 220 flexibly connected thereto. The display panel is disposed over the backlight assembly 100 and controls a transmittance of the light passing therethrough to display the desired image, and the flexibly attached printed circuit board 220 is rotated to be arranged at one side of the display panel 210 to output driving signals (e.g., data line driving signals and/or gate line driving signals) to a so-called TFT array substrate of the display panel 210.

The display panel 210 may be a liquid crystal display panel that includes a lower substrate (TFT array substrate) 211, an upper substrate (common electrode substrate) 212 facing the lower substrate 211, and a liquid crystal layer disposed between the lower substrate 211 and the upper substrate 212. The printed circuit board 220 is connected to the display panel 210 through a plurality of flexible tape carrier interconnect strips 230 and a plurality of driving chips 231 mounted on the tape carrier strips 230, respectively.

Each of the driving chips 231 may be provided with a data driver built therein to output data line signals to the display panel 210. In the present exemplary embodiment, a gate driver (not shown) that outputs gate line signals to the display panel 210 may be directly formed on and integrated with the display panel 210 through a thin film process.

In addition, the driving chips 231 may be mounted on the display panel 210 as a chip-on-glass structure. In this case, the driving chips 231 may be integrally formed in one chip.

The printed circuit board 220 may be mounted along the exterior of a sidewall of the container 110 when assembling the display apparatus 300, and the inverter PCB 140 of the backlight assembly 100 may be also mounted along the exterior of the same sidewall side of the container 110. When the size of the inverter PCB 140 decreases, a space use efficiency of the sidewall of the container 110 may be improved, thereby reducing a total thickness of the display apparatus 300.

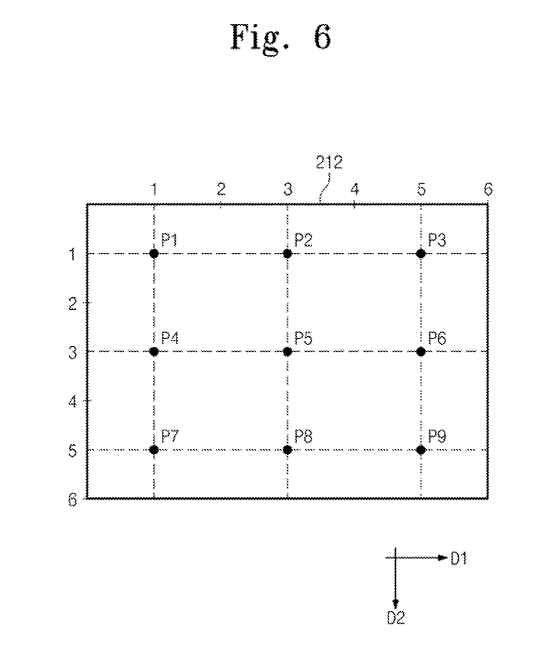

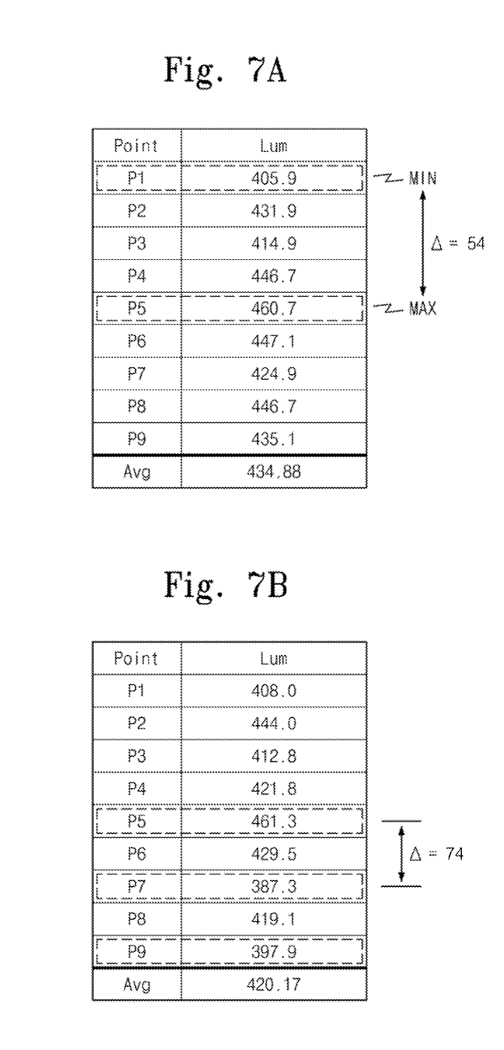

FIG. 6 is a diagram showing brightness measurement points for brightness values of the display panel of FIG. 5, and FIGS. 7A and 7 B are tables showing brightness values measured at the brightness measurement points (nine sample points) of FIG. 6. Particularly, FIG. 7A shows brightness values measured at the display panel receiving the light from the backlight assembly 101 shown in FIG. 3, and FIG. 7B shows brightness values measured at a display panel receiving a light from a backlight assembly which employs a double-sided driving method in that a driving power is applied to a first terminal and a second terminal of a U-shaped lamp.

Referring to FIG. 6, nine brightness measure points are obtained by equally dividing a test display panel (like 210) by six times in an x-axis direction (D1) and equally dividing by six times in a y-axis direction (D2). That is, a first point P1 corresponds to coordinates (1, 1), a second point P2 corresponds to coordinates (3, 1), and a third point P3 corresponds to coordinates (5, 1). Also, a fourth point P4 corresponds to coordinates (1, 3), a fifth point P5 corresponds to coordinates (3, 3), and a sixth point P6 corresponds to coordinates (5, 3). A seventh point P7 corresponds to coordinates (1, 5), an eighth point P8 corresponds to coordinates (5, 3), and a ninth point P9 corresponds to coordinates (5, 5). The test display panel need not have a working LCD panel in it or light diffusing plates because the thing being tested is merely the locally average luminance at the 9 sample points across the display area.

Accordingly, the first to third points P1˜P3 are positioned at an upper area of the display panel 210, the fourth to sixth points P4˜P6 are positioned at a center area of the display panel 210, and the seventh to ninth points P7˜P9 are positioned at a lower area of the display panel 210.

Referring to FIG. 7A, among the first to ninth points P1˜P9, the highest brightness value of about 460.1 nit has been measured at the fifth point P5, and the lowest brightness value of about 405.9 nit has been measured at the first point P1. Also, a total average of the measured brightness values measured at the first to ninth points P1˜P9 has been of about 434.88 nit.

In addition, according to FIG. 7A, a difference between the highest brightness value and the lowest brightness value has been computed at about 54.8 nit.

Referring to FIG. 7B, among the first to ninth points P1˜P9, the highest brightness value of about 461.3 nit has been measured at the fifth point P5, and the lowest brightness value of about 387.3 nit has been measured at the seventh point P7. Also, an average of the measured brightness values measured at the first to ninth points P1˜P9 has been of about 420.17 nit.

According to FIG. 7B, a difference between the highest brightness value and the lowest brightness value has been computed at about 74 nit. Consequently, when the display panel employs the backlight assembly 101 according to the present disclosure, the average brightness value becomes higher and the difference between the highest brightness value and the lowest brightness value becomes smaller by about 20 nit. Thus, when the backlight assembly 101 is employed as a light source for the display panel, the brightness and the brightness uniformity may be improved.

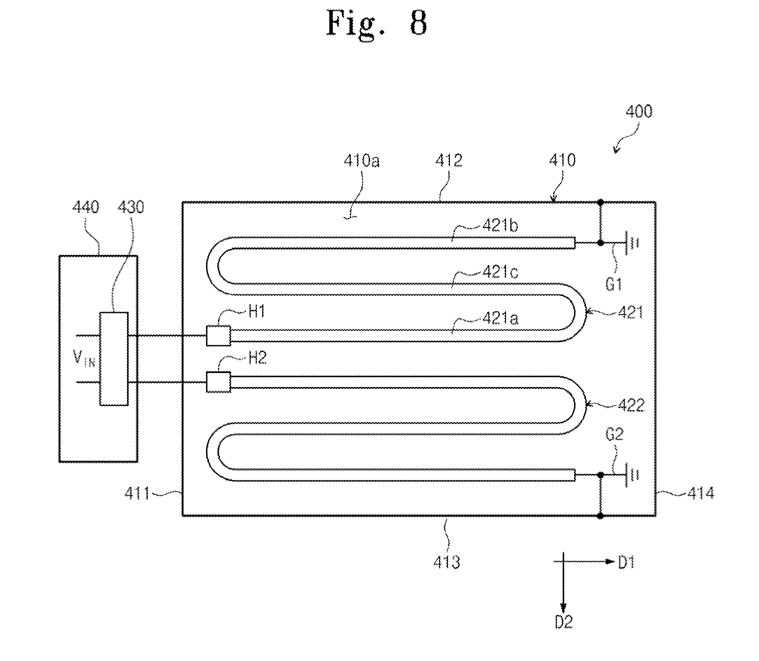

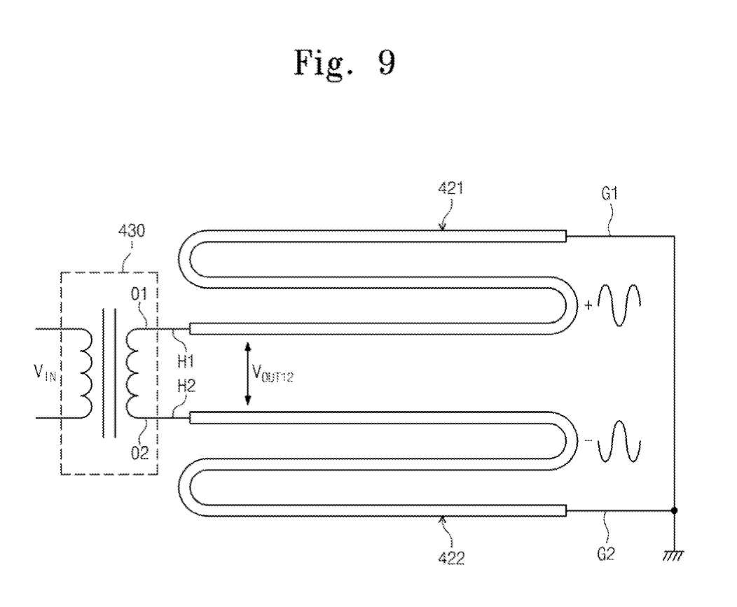

FIG. 8 is a plan view showing a backlight assembly according to another exemplary embodiment. FIG. 9 is a circuit diagram showing a connection relation between a transformer and a plurality of lamps of FIG. 8.

Referring to FIGS. 8 and 9, a backlight assembly 400 includes an electrically conductive container 410, a plurality of multi-bend lamps 421 and 422, a voltage step-up transformer circuit 430, and a printed circuit inverter board 440 to which the transformer 430 is mounted where the PCB inverter board 440 is understood to have drive electronics (not shown) further mounted thereon for driving the step-up transformer circuit 430 with an AC input voltage signal.

As shown in FIG. 8, the container 410 has a rectangular shape and the lamps 421 and 422 are contained in a containing space 410a of the container 410. In FIG. 8, two lamps, for example, a first lamp 421 and a second lamp 422 have been shown, but the number of the lamps should not be limited thereto. That is, in case that the size of the backlight assembly 400 becomes larger or the required brightness increases, the number of the lamps may increase. Hereinafter, since the first lamp 421 and the second lamp 422 have the same structure and function (but are mounted in mirror image symmetry relative to one another), for the convenience of explanation, the first lamp 421 will be described in detail as a representative example.

The first lamp 421 includes a first terminal H1 (high-voltage terminal) and a second terminal G1 (grounded terminal) respectively at the opposed ends of its multiply-bent length. In the present exemplary embodiment, the first lamp 421 is bent twice, so the first lamp 421 has an S-shape and includes three straight-line-shaped lamp segments 421a, 421b, and 421c that each are extended in a first direction D1 and where the linear segments are arranged one after the other in a second direction D2.

A first straight-line-shaped lamp segment 421a and a second straight-line-shaped lamp segment 421b, each of which is positioned at an outermost position among the three straight-line-shaped lamp segments 421a, 421b, and 421c of that lamp, are respectively provided with the first terminal H1 and the second terminal G1. More particularly, the first straight-line-shaped lamp segment 421a is connected via the first terminal H1 to a corresponding high-voltage output node (O1) of the step-up transformer circuit 430. The second straight-line-shaped lamp segment 421b is connected via the second terminal G1 to a grounded point at the bottom and/or inner sidewall (412) of the electrically conductive container 410. The first terminal H1 is positioned adjacent to the left sidewall 411 of the container 410 and the second terminal G1 is positioned adjacent to an opposite sidewall 414 of the container 410. Similar to the number of the lamps, the number of the straight-line-shaped lamp segments should not be limited to the illustrated number, and the number of the straight-line-shaped lamp segments may increase according to the size of the backlight assembly 400 and the required brightness. Also, in case that bending times of the each lamp increase, the number of the lamps disposed in the backlight assembly 400 may reduce.

Referring to FIG. 9, the transformer circuit 430 boosts an input AC voltage to a driving AC voltage and provides the boosted driving voltage to the first terminals H1 and H2 of the first and second lamps 421 and 422. In the present exemplary embodiment, the transformer circuit 430 may be a 2-in-2-out transformer having two input terminals and two higher-voltage output terminals, for example, a first output terminal O1 and a second output terminal O2.

In this case, the first output terminal O1 of the transformer 430 is connected to the first terminal H1 of the first lamp 421 and the second output terminal O2 is connected to the first terminal H2 of the second lamp 422. Therefore, the one transformer circuit 430 may apply the driving current of appropriate voltage and power to the first lamp 421 and the second lamp 422 where the current loop completes by virtue of the mutual grounding of second terminals G1 and G2 of the lamps. The driving voltage signal applied to the first terminal H1 of the first lamp 421 has a phase opposite to a phase of the driving voltage signal applied to the first terminal H2 of the second lamp 422. Thus, a waterfall noise may be prevented from occurring between the first lamp 421 and the second lamp 422.

As described above, when the one transformer circuit 430 is configured to drive the first and second lamps 421 and 422, the size of the transformer circuit 430 becomes smaller and the electrostatic leakage current at the output winding of the transformer circuit 430 arranged as shown in the backlight assembly 400 decreases because the high-voltage nodes, H1 and H2 can be spaced safely away from at least three of the sidewalls, 412, 413, 414 of the container 410. In one embodiment, at least a central part of the left sidewall 411 may be made of an electrically insulative material such as a ceramic and/or a plastic so that the O1 and O2 wires of the transformer and the H1 and H2 terminals of the lamps can be safely spaced apart from grounded metal parts so as to reduce high-voltage leakage current therebetween. Since only the two transformer output wires, O1 and O2 (or corresponding terminal extensions thereof) need to connect to the lamps assembly 421/422; consequently, the number of the parts arranged on the PCB inverter board 440 may be reduced (e.g., by not requiring ground terminals), thereby decreasing the total size of the PCB inverter board 440. In other words, when compared to the transformer circuit 130 that drives the first to fourth lamps 121˜124, the transformer circuit 430 that drives the first and second lamps 421 and 422 has a small size and a half number of terminals although the transformer circuit 430 provides the light to the same area, and thus the size of the PCB inverter board 440 decreases by about 50% or more.

Meanwhile, each of the linear segments of the first and second lamps 421 and 422 is extended in a first direction D1 and the linear segments are arranged one adjacent to the next in a second direction D2 that is substantially perpendicular to the first direction D1.

As shown, the second terminal G1 of the first lamp 421 is positioned closer to the top and right sidewalls 412/414 of the container 410 than is the first terminal H1 thereof. Similarly, the second terminal G2 of the second lamp 422 is positioned closer to the bottom and right sidewalls 413/414 of the container 410 than is the first terminal H2 of the second lamp 422. As a result, electric field intensity may gradually and smoothly decrease as one moves from the highest voltage (highest in terms of absolute magnitude) zones immediately around the H1 and H2 terminals and along the length of each lamp towards the grounded corner regions of the container where right sidewall 414 meets with top sidewall 412 or with bottom sidewall 413.

In general, the wall of the container 410 are maintained at the ground potential (except that left sidewall 411 may have an electrically insulative portion through which wires O1, O2 or equivalents thereof extend to meet up with lamp terminals H1 and H2). If hypothetically speaking, the first terminals H1 and H2 had instead been disposed more adjacent to the top and bottom sidewalls, 412 and 413 of the container 410, a greater electrostatic leakage current may be generated between those sidewalls of the container 410 and adjacent lengths of the first and second lamps 421 and 422. Such greater leakage current could cause deterioration in brightness near the top and bottom side walls 412 and 413 of the container 410 if that hypothetical arrangement had been used instead of one shown in FIG. 8.

Accordingly, in order to prevent or reduce such undesirable leakage current, the first terminal H1 of the first lamp 421 is positioned closer to a left central portion of the container and the first terminal H2 of the second lamp 422 is also positioned closer to the left central portion of the container 410 while the grounded terminals G1 and G2 are disposed more adjacent to the well grounded top and bottom right corners of the container 410. Since the second terminals G1 and G2 receive a voltage having a relatively lower level than a voltage applied to the first terminals H1 and H2, the leakage current occurring between the first lamp 421 and the top side wall 412 and between the second lamp 422 and the bottom side wall 413 may decrease. Thus, the deterioration of the brightness near the top and bottom sidewalls 412 and 413 may be prevented, thereby improving the brightness uniformity of the backlight assembly 400.

In addition, the second terminals G1 and G2 of the first and second lamps 421 and 422 may directly contact with the container 410 to be grounded through the container 410. When the second terminals G1 and G2 of the first and second lamps 421 and 422 are so grounded through the container 410, no additional ground wires or terminals to ground the second terminals G1 and G2 by way of PCB 440 are required on the PCB inverter board 440. That is, since the ground terminal(s) may be omitted from the PCB inverter board 440, the size of the PCB inverter board 440 may be reduced.

Although exemplary embodiments in accordance with the disclosure have been provided, it is understood that the present teachings should not be limited to these exemplary embodiments but various changes and modifications can be made by one ordinary skilled in the art in light of the foregoing and within the spirit and scope of the present teachings.

What is claimed is:

1. A backlight assembly comprising:
a container having grounded electrically conductive parts;
a plurality of lamps each having one or more bends and linear lamp segments extending from the one or more bends to thus define a corresponding lightable length of the lamp, the lamps being contained and positioned in the container such that their respective linear lamp segments extend substantially in a first direction, each of the lamps having a first electrical terminal for receiving a voltage of relatively high absolute magnitude and a second electrical terminal for receiving a voltage of relatively low absolute magnitude where the different between the received high and low voltage magnitudes is sufficient to keep the lamp lit; and
a voltage step-up transformer circuit having one or more output windings, each output winding having at least two output terminals where between there can develop as a result of a predetermined input AC voltage being applied to the step-up transformer circuit, an AC output voltage of sufficient magnitude to light a connected series of at least two of the lamps,
wherein for a given winding, said connected series of at least two lamps is formed by a corresponding two or more of the lamps each having the second electrical terminal thereof connected to an adjacent and grounded electrically conductive part of the container and having the first electrical terminal thereof connected to a corresponding one of the at least two output terminals of the given winding.

2. The backlight assembly of claim 1, wherein the transformer circuit comprises two output windings connected to respectively serve a first series connected set and a second series connected set of the lamps.

3. The backlight assembly of claim 2, wherein the first series connected set and the second series connected set of lamps are positioned so that the first electrical terminals (the high voltage terminals) of each of the first and second series connected sets are disposed farther away from a corresponding one of the sidewalls of the container than is disposed at least one of the second electrical terminals (the low voltage terminals) of each of the first and second series connected sets from the corresponding one of the sidewalls of it set.

4. The backlight assembly of claim 2, wherein the first series connected set and the second series connected set of lamps are positioned so that the first electrical terminals (the high voltage terminals) of each of the first and second series connected sets are disposed adjacent to one another.

5. The backlight assembly of claim 1,
wherein the container comprises a first sidewall and a second sidewall that are arranged in parallel with the first direction, and the lamps comprise a first outermost lamp of which the second terminal (the low voltage terminal) is positioned closer to the first sidewall of the container than is the first terminal of the first outermost lamp; and
wherein a second outermost lamp of lamps has its second terminal positioned closer to the second sidewall of the container than is the first terminal of the second outermost lamp.

6. The backlight assembly of claim 5, wherein the second terminals of the first and second outermost lamps directly are directly connected with the container, and the second terminals of remaining lamps are electrically connected to the container through the second terminals of the first and second outermost lamps.

7. The backlight assembly of claim 1, wherein the first terminal and the second terminal of each lamp are disposed adjacent to one sidewall of the container.

8. The backlight assembly of claim 7, wherein each of the lamps has a U-shape.

9. The backlight assembly of claim 1, wherein a driving voltage applied to the first terminal of one of two adjacent lamps has a phase opposite to a phase of a driving voltage applied to the first terminal of remaining one of the two adjacent lamps.

10. The backlight assembly of claim 1, wherein the transformer circuit comprises two output terminals connected to first terminals of two corresponding lamps, respectively, among the lamps to apply the driving voltage to the first terminals.

11. The backlight assembly of claim 1, wherein each of the lamps has an S-shape.

12. A display apparatus comprising:
a backlight assembly structured to generate a backlighting light; and
a display panel disposed to receive the backlighting light and structured to display an image formed from the received backlighting light,
wherein the backlight assembly comprises:
a container having grounded electrically conductive parts;
a plurality of lamps each having one or more bends and linear lamp segments extending from the one or more bends to thus define a corresponding lightable length of the lamp, the lamps being contained and positioned in the container such that their respective linear lamp segments extend substantially in a first direction, each of the lamps having a first electrical terminal for receiving a voltage of relatively high absolute magnitude and a second electrical terminal for receiving a voltage of relatively low absolute magnitude where the different between the received high and low voltage magnitudes is sufficient to keep the lamp lit; and
a voltage step-up transformer circuit having one or more output windings, each output winding having at least two output terminals where between there can develop as a result of a predetermined input AC voltage being applied to the step-up transformer circuit, an AC output voltage of sufficient magnitude to light a connected series of at least two of the lamps,
wherein for a given winding, said connected series of at least two lamps is formed by a corresponding two or more of the lamps each having the second electrical terminal thereof connected to an adjacent and grounded electrically conductive part of the container and having the first electrical terminal thereof connected to a corresponding one of the at least two output terminals of the given winding.

13. The display apparatus of claim 12, wherein the transformer circuit comprises four output terminals respectively connected to first terminals of four corresponding lamps among the lamps to apply the driving power to the first terminals.

14. The display apparatus of claim 13, wherein the four lamps comprise a first lamp, a second lamp, a third lamp, and a fourth lamp that are sequentially arranged in the second direction, first terminals of the first and second lamps are adjacent to each other, first terminals of the third and fourth lamps are adjacent to each other, and second terminals of the second and third lamps are adjacent to each other.

15. The display apparatus of claim 14, wherein the four lamps comprise a first lamp, a second lamp, a third lamp, and a fourth lamp that are sequentially arranged in the second direction, first terminals of the second and third lamps are adjacent to each other, a first terminal of the first lamp is adjacent to a second terminal of the second lamp, and a first terminal of the fourth lamp is adjacent to a second terminal of the third lamp.

16. The display apparatus of claim 12, wherein the container comprises a first sidewall and a second sidewall that are arranged in parallel with the first direction, and
the outermost lamp comprises a first outermost lamp of which the second terminal is positioned closer to the first sidewall of the container than the first terminal thereof and a second outermost lamp of which the second terminal is positioned closer to the second sidewall of the container than the first terminal thereof.

17. The display apparatus of claim 12, wherein the second terminals of the first and second outermost lamps directly make contact with the container, and the second terminals of remaining lamps are electrically connected to the container through the second terminals of the first and second outermost lamps.

18. The display apparatus of claim 12, wherein each of the lamps has a U-shape lamp.

19. The display apparatus of claim 12, wherein the first terminals of two adjacent lamps receive the driving power having a phase opposite to each other.

20. A method of providing backlighting light to an image display apparatus, the method comprising:
providing a container having grounded parts;
providing a voltage step-up transformer circuit having at least one output winding structured to develop an output AC voltage sufficient to light at least two series connected lamps;
providing a series connected set of at least two bent lamps contained in the container, the series connected set being connected to receive the output AC voltage from the at least one output winding as a series driving voltage and the series connected set having its series connection defined by two of the lamps having electrical terminals thereof interconnected through a grounded part of the container.
